(19) United States
(12) Patent Application Publication
(10) Pub. No.: US 2010/0209725 A1
(43) Pub. Date: Aug. 19, 2010

(54) METHOD OF MODIFYING PAPER AND CARDBOARD

(76) Inventors: Kirsi Kataja, Espoo (FI); Terhi Saari, Espoo (FI); Pia Qvintus-Leino, Espoo (FI); Soili Peltonen, Espoo (FI); Sari Hyvarinen, Espoo (FI); Henna Lampinen, Espoo (FI); Pertti Moilanen, Espoo (FI); Juhani Paukku, Espoo (FI)

Correspondence Address: MCCORMICK, PAULDING & HUBER LLP, CITY PLACE II, 185 ASYLUM STREET, HARTFORD, CT, 06103, US

(21) Appl. No.: 12/602,551

(22) PCT Filed: Jun. 2, 2008
(86) PCT No.: PCT/FI08/50319

§ 371 Date: Apr. 22, 2010

(30) Foreign Application Priority Data
Jun. 1, 2007 (FI) 20070440

(51) Int. Cl. B32B 29/00; B05D 1/28; B05D 1/30; B05D 1/02; B05D 3/12

(52) U.S. Cl. 428/533; 427/428.01; 427/420; 427/421.1; 427/364

(57) ABSTRACT

A fibrous product, the absorption and desorption properties of which have been improved and which comprises a fibrous substrate which has, on at least one of it surfaces, a small quantity of a modified starch, and a method of producing it. According to the present invention, onto at least one surface of the fibrous product is applied 0.01-1.0 g/m² of starch ether ester, anionic starch ester, or starch ether or ester, from a diluted aqueous solution or aqueous dispersion. By means of the present invention it is possible efficiently to reduce the absorption of printing ink into a surface to be printed. Consequently, the desired density is achieved with a smaller printing ink quantity and, at the same time, harmful print-through of imprints is reduced.

### CROSS REFERENCE TO RELATED APPLICATIONS

This application is entitled to the benefit of and incorporates by reference essential subject matter disclosed in International Patent Application No. PCT/FI20081050319 filed on Jun. 2, 2008 and Finnish Patent Application No. 20070440 filed Jun. 1, 2007.

### FIELD OF THE INVENTION

The present invention relates to a method of treating fibrous products, in particular in order to modify their surface.

In a method of the present kind, a starch-based polymer is applied on the surface of fibrous products, in order to adjust the absorption and desorption properties of these.

The present invention also relates to a fibrous product.

### BACKGROUND OF THE INVENTION

The properties of the base paper of a printing paper has an effect on how the vehicles of the printing inks and the solvent-borne printing inks, respectively, are absorbed into the paper and how the water is removed from the paper. Consequently, in uncoated printing papers, such as offset and copying papers, a high-quality chemical pulp and calcium carbonate filler is generally used in order to achieve absorption properties which are as uniform as possible. In other qualities, such as graphic papers, the base paper is coated at least once, mostly 2-3 times, with a mineral pigment paste to make the surface smooth and to reduce the spreading of the dissolvent.

Mineral pigmentation increases the price of the product and makes it difficult to recycle the fibre fraction. It is also desirable that wood-containing fibrous pulps can be increasingly used in high-quality printing products, too, in order to reduce the costs of the fibre share.

### SUMMARY OF THE INVENTION

It is an aim of the present invention to eliminate the disadvantages associated with the known technology and to provide a completely new solution for treating the fibrous product which is used as a printing substrate, and in particular of improving the printing properties of the fibrous product.

The present invention is based on the idea that it is possible to decrease the effect of the properties of the base paper on the final paper product, by using chemical treatment to modify the surface of the paper, cardboard or corresponding fibrous products which are designed for printing purposes, in which case it is possible to simplify the structure and the production process of the paper and to use more inexpensive raw materials.

In connection with the present invention it has been found that by applying very small quantities of a modified starch onto the printing surface of a fibrous product, either as spots or in the form of a continuous film, to cover at least a part of the surface, it is possible to influence the absorption of the solvents or the solvent-borne printing inks, as well as the removal of water from the fibrous product. Examples of suitable modified starches are products which are generated from starch by chemical derivatization to give products that can be anionic, cationic or non-ionic and from which it is possible to generate diluted aqueous solutions or aqueous dispersions.

The absorption and desorption properties of the fibrous product according to the present invention are improved and the product comprises a fibrous substrate, at least one surface of which has a small quantity of modified starch, preferably less than 1 g/m².

More specifically, the method according to the present invention is mainly characterized in that a small amount of a modified starch is applied on at least one side of the fibrous product.

The product according to the present invention is characterized in that the paper or cardboard web, which has been treated with the starch modification, is calendered after the polymer treatment.

Considerable advantages are achieved with the present invention. Thus, with this treatment it is possible to efficiently decrease the absorption of the printing ink in the surface to be printed. With a smaller quantity of printing ink it is thus possible to achieve a desired density and, at the same time, reduce the harmful print-through of imprints by at least 5%, especially at least 10%, preferably even 20% or more, compared with an untreated reference. It is possible to reduce the coating quantity of paper or cardboard and/or use a more inexpensive base paper/cardboard. If needed, the same base paper/cardboard quality can be used for several end products.

Using the present invention, it is possible either to improve the quality of the imprint on the current paper grades or to produce a new product to replace the current printing paper, by using a simpler and/or more competitive and thus more profitable production concept:

the quantity of the mineral coating can be reduced, in which case less oil-based coating binding agent is needed, too.

the properties of a more inexpensive (and lower-quality) fibrous network can be improved and it can be used after treating it with polymer before the coating,

if needed, the same simplified base paper can be tailored to suit a certain end product/printing technique, and

the quantity of the printing ink can be reduced because the ink does not penetrate as deep into the fibrous network as before.

Fast desorption of the water from the paper in a hot roll nip (electrophotography printing) normally results in harmful curling of the paper. By using the present invention, it is possible to substantially reduce this curling. Tests show that the curling can be reduced by at least 5%, especially at least 10%, preferably even 20% or more.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the following, the present invention will be examined more closely with the aid of a detailed description and the accompanying drawings.

FIG. 1 is a bar chart, which shows the results of IGT gravure printing when a non-ionic starch ether ester is used,

FIG. 2 shows the results of pilot-scaled gravure printings,

FIG. 3 shows the water absorption results for base papers which are treated with non-ionic hydroxypropyl starch (N2) and anionic starch octenyl succinate (A1),

FIG. 4 shows the mineral oil absorption results for base papers which are treated with non-ionic hydroxypropyl starch (N2) and anionic starch octenyl succinate (A1),

FIG. 5 shows the mineral oil absorption results for base papers which are treated with non-ionic hydroxypropyl starch (N2) and anionic starch octenyl succinate (A1),

FIG. 6 shows the preabsorption results for base papers which are treated with non-ionic hydroxypropyl starch (N2) and anionic starch octenyl succinate (A1),

FIG. 7 shows the mineral oil absorption results for pre-coated base papers which are treated with four different starch modifications,

FIG. 8 describes the behaviour of inkjet printing ink drops on papers which are treated in different ways,

FIG. 9 is a bar chart, which shows how two modified starches affect the curling of paper,

FIG. 10 shows how the molecular weight affects the z-direction distribution of starch in the paper,

FIG. 11 shows how the molecular size of hydroxypropylated potato starch affects the absorption properties of the paper,

FIG. 12 shows how the molecular size of hydroxypropylated potato starch affects the surface strength of the paper,

FIG. 13 shows how the degree of substitution of hydroxypropylated potato starch affects the z-direction distribution of starch in the paper, and

FIG. 14 shows how the degree of substitution of hydroxypropylated potato starch affects the absorption properties of the paper.

### DETAILED DESCRIPTION OF THE PREFERRED EMBODIMENTS

As will appear from above, according to the present invention, it is possible to change the surface properties of fibrous products by using a very small quantity of starch modification. This modification is applied at least on one side of the fibrous product, in which case the application quantity is at least 0.01 g/m², but typically less than 1 g/m², in particular at maximum approximately 0.8 g/m², on each side of the fibrous product. More preferably, the application quantity is approximately 0.05-0.5 g/m²/side. Preliminary tests have shown that already slightly larger application quantities results in such effects in the surface of the fibre layer, which are different from those achieved with small quantities, as described in more detail below.

Here, a modified starch denotes a starch derivative (polymer) which is generated from starch, especially by using a chemical treatment. Most suitably, a starch derivative, whose affinity for fibre substrate, printing ink, printing ink dissolvents or a combination of these, has been changed and improved, is used in the present invention. Typically, a starch derivative which comprises structures that increase the hydrophilic or hydrophobic character of the starch, is used in the present invention. In addition, it is possible to use a modified starch which comprises both hydrophilic and hydrophobic structures (for instance hydroxypropyl and acetate groups). As a result of the modification, the modified starch is attached to the surface of the fibrous product and is thus capable of changing the properties of the fibre surface.

The modified starch can be either cationic, anionic or non-ionic. This product is applied, from an emulsion, a dispersion or a solution, in small quantities onto the surface of the fibrous product, which means that suitable products are such starch modifications, from which it is possible to prepare sprayable diluted emulsions, dispersions or solutions. However, this does not mean that, according to the present invention, the starch modification can be applied only by spraying. In fact, it is possible to carry out the application by spraying but also for instance by roll coating or film transfer coating, as described in more detail below.

It should be noted that, as a result of the modifying described above, a modified starch is generally easier than starch to dissolve or to disperse in water, which makes it easier to apply it from a diluted aqueous phase.

Starch esters, starch ethers and starch ester ethers are particularly interesting types of starch modifications which are suitable for the present invention. More preferable examples are the following: anionic starch alkenyl succinate, non-ionic hydroxypropyl starch, non-ionic carboxymethyl starch, non-ionic hydroxypropylated starch ester, such as hydroxypropylated starch acetate, starch acetate, cationic starch and mixtures of these.

The starch or the derivative of starch from which the starch modification is formed, and which have a composition according to the present invention, can be based on any natural starch (native starch), the amylose content of which is 0-100% and the amylopectin content 100-0%. Accordingly, the starch component can be sourced from barley, potato, wheat, oats, pea, corn, tapioca, sago, rice, or similar tuber vegetables and cereal crops. It can also be based on starches which have been produced by oxidizing, hydrolyzing, crosslinking, cationization, grafting, etherifying or esterifying of the natural starches described above.

According to a first embodiment, the starch modification used is a starch ether, for instance carboxy-lower alkyl-starch or hydroxy-lower alkyl-starch, in which the lower alkyl group is methyl, ethyl, n- or i-propyl, or n-, i- or t-butyl. Examples of these are carboxymethyl starch and hydroxypropyl starch.

It is possible to produce a starch modification such as this for instance by hydroxyalkylation of starch to a predefined molecular degree of substitution. Production of hydroxypropyl ethers is described for instance in U.S. Pat. No. 3,033,853.

In the case of ethers, particularly good results have been achieved with MS values which are below 1 (see Example 6).

After that, the hydroxypropyl ethers are optionally esterified. It is possible to carry out the esterification in a way which is known per se (see for instance FI Patent Specification No. 107930). According to a preferred embodiment, acetylated hydroxypropyl starch is used, which can be produced from hydroxypropyl starch by bringing this to react with an acetic anhydride.

The molecular degree of substitution, MS, of hydroxyalkylated starch ester can be 0.5-4 and the degree of substitution of ester groups (DS) 0-3. According to an embodiment, hydroxypropyl starch acetate is used, the MS of which is typically 0.05-2 and DS is 0.3-3.

The anionic starch esters used are for instance starch or starch derivative alkenyl succinate, such as starch or starch derivative octenyl succinate. Generally, the alkenyl group of the alkenyl succinate is derived from an alkene comprising 3-24, preferably 3-12 carbon atoms, such as octenyl.

It is possible to produce alkenyl succinate by bringing an initial material, such as starch, to react with an alkenyl succinic anhydride which corresponds to ester, for instance in an aqueous phase, in which case an aqueous dispersion of alkenyl succinate is generated. The quantity of the succinic anhydride is as much as double the mass of the starch. However, the quantity of the alkenyl succinic anhydride is most suitably 0.01-95 weight-%, preferably approximately 1-50 weight-% of the dry matter mass of the starch. Generally, the quantity is 70 weight-% or less of the dry matter.

Starch esters, too, are suitable for use in the present invention. See for instance FI Patent Specification No. 107386.

Furthermore, with the molecular weight and the degree of substitution of the starch modifications it is possible to affect the penetration of the starch modifications into the fibrous product. By setting the degree of substitution it is, in turn, possible to affect the affinity between the polymer and the fibrous product.

Generally, the average molecular weight is approximately 5,000-2,500,0000 g/mol. However, in the examples below, it has been found that the best results are achieved when the molecular weight (M_{W}) of the starch modification is approximately 40,000-2,000,000 and especially approximately 100,000-1,500,000 g/mol.

Besides pure products, it is also possible to use mixtures of starch polymers and other polymers, such as commercial polyvinyl alcohols. In polymer mixtures such as these, the quantity of the starch modifications is generally at least 10 weight-%, and especially the percentage is 50 weight-% of the total quantity of the mixture.

The modified starch can be applied onto the surface of the substrate by using conventional methods, for instance roll coating, blade coating, spray coating and curtain coating. Typically, the modified starch is applied in the form of an aqueous emulsion, aqueous dispersion, colloidal solution or aqueous solution.

The percentage of the polymer in the emulsion, dispersion or solution to be applied is generally approximately 0.01-30%, especially approximately 0.1-20%, generally approximately 1-10%, calculated from the mass of the emulsion, the dispersion or the solution. However, the solids percentage of the starch modification in an undiluted emulsion, dispersion or solution can be as much as 90 weight-%, generally approximately 20-90 weight-%, especially approximately 30-85 weight-%.

In spray coating, the polymer solutions can be significantly diluted, their dry matter percentages can be less than 4%.

According to a preferred embodiment of the present invention, the polymer which is applied onto the surface of the substrate forms individual drops or spots, which are at least partly separated from each other. In this embodiment, the structure of the fibrous product is not blocked. Instead, its surface is chemically affected.

By bringing the starch modification onto the surface of the fibrous product in the form of a dispersion or an emulsion, after the application it will remain on the surface as discrete dots or spots. It is possible to spread out and smooth out at least part of these spots by using calendering or a similar smoothing treatment which is especially carried out at an elevated temperature. When the spots or dots are spread out, they can merge and form a uniform surface on the top of the fibre layer.

However, in association with the application, it is possible to form a homogeneous, thin layer which is generally at maximum approximately 500 nm (for instance approximately 10-500 nm) thick. Especially, it is possible to generate a layer such as this by using a starch modification which is fundamentally water-soluble. According to an embodiment of the present invention, with this layer it is possible to cover at least part of the fibre layer.

It is possible to modify any fibrous substrate, when using the method according to the present invention. In particular, the fibrous material is paper, cardboard, cellulose sheet, paper or cardboard or mass made from recycled fibre, or fabric, natural fibre mass or sheet or fabric made from synthetic fibres, such as fibre fabric, or three-dimensional pieces made from the above materials. In addition, the fibrous material can comprise other components, such as fillers.

Particularly, a paper, cardboard or a similar fibrous product which is treated according to the present invention is most suitable as a printing bed already as such, without any additional treatment. The example above demonstrates that when water-soluble ink was applied onto both a coated and an uncoated area, much less of the ink was absorbed in the area that was coated; moreover the ink did not spread out any wider. However, the absorption of the printing ink is sufficient to ensure that the ink remains in the surface.

The grammage of the paper or cardboard or similar fibrous material to be treated can vary freely, however, typically it is approximately 50-500 g/m². Generally, the grammage of the base paper is 30-300 g/m², preferably approximately 30-80 g/m² for papers, and 90-400 g/m² for cardboards.

Regarding paper and cardboard, the substrate is typically a wood-containing or wood-free web, i.e. a base paper or base cardboard, the fibres of which are cellulose-based or lignocellulose-based. Examples of these are LWC, SC, FP (fine papers) and base papers of chemical pulp paper, fluting paper and folding boxboard. The fibres of the products can be virgin fibres or recirculated fibres.

Above all, the present invention is applied on uncoated base paper or base cardboard, but it is also possible to use it for instance for a fibrous web which is coated with mineral pigments or a fibrous web which is surface sized in a conventional way. Tests have shown that even with small amounts it is possible practically to block the water absorption of especially pre-coated materials.

We have observed changes of the surface properties of both wood-free (FP) and wood-containing (LWC) paper.

Examples of the fillers of the fibrous materials are mineral fillers, such as calcium carbonate and kaolin. The mineral pigment of a pre-coating can be an ordinary coating pigment, for instance kaolin, calcium carbonate (GCC), precipitated calcium carbonate (PCC), gypsum, talc or a mixture of these.

More preferably, the present invention is suitable for the treatment of paper and cardboard webs and sheets, but it is also possible to modify for instance wood fibres which are used in insulating materials.

After the treatment, a surface is generated, the properties of which vary according to what kind of starch modification has been used.

As discovered above, the hydrophilicity/hydrophobicity of the starch modification has been changed compared with native starch, in which case it is possible, for instance onto a hydrophilic surface, such as a web comprising chemical cellulose, to apply a derivative comprising hydrophilic parts or structures, and, correspondingly, onto a hydrophobic surface, such as a web comprising lignocellulose, it is possible to apply a derivative comprising hydrophobic points or structures. After the treatment, the properties of the surface are at least partly determined according to, besides the hydrophilic/hydrophobic parts, the chemical nature of the starch modification that is applied onto the surface. Those parts remain free of the surface. By attaching a modified starch, which has a hydrophobic tail, onto the hydrophilic surface, it is possible to increase the hydrophobicity of the surface, in which case the water repulsion ability of the surface is improved and, at the same time, the absorption of oil and organic dissolvents increases. On the other hand, by applying a starch modification comprising a hydrophilic tail primarily onto a hydrophobic surface, it is possible to increase the hydrophilicity, in which case the absorption of oil and organic dissolvents decreases.

We have found that for certain derivatives, the properties of the surface vary depending on the applied quantity. Consequently, a dispersion of hydroxyalkyl ester of starch (N1) in small quantities (at maximum 0.5 g/m²/surface) generally gives a hydrophilic surface when LWC base paper is used, but when greater quantities (>1 g/m²-3.0 g/m²) of this modification are applied onto the fibrous web, a hydrophobic surface is generated.

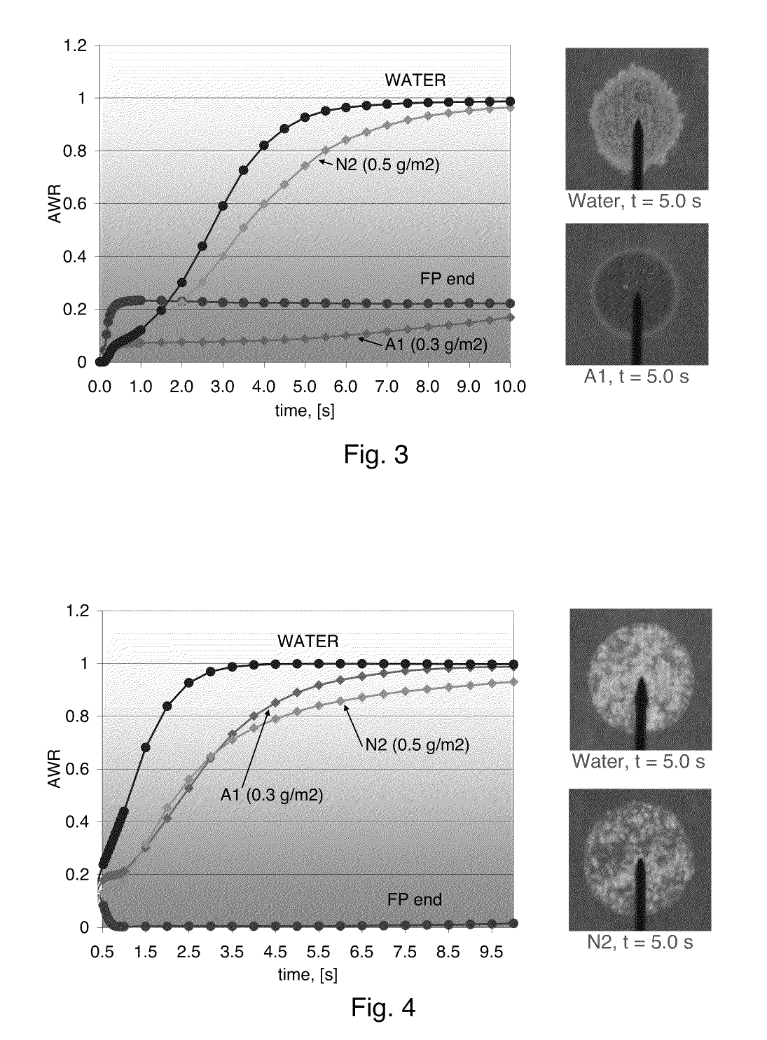

However, the anionic alkenyl succinate ester of starch acts differently when different base paper surfaces are used, and makes a FP base paper hydrophobic and a LWC base paper hydrophilic, at coating quantities of 0.3 g/m² (see the accompanying FIGS. 3 and 6).

A paper or cardboard web, which has been prepared as described above, can be further treated by surface-sizing, coating or calendering it, depending on the application. As mentioned above, a treatment according to the present invention makes it possible to modify the web and not use any other treatment, except, possibly, calendering.

It is possible to carry out the calendering as on-line calendering or as offline calendering, for instance by using an online-soft-calender or an offline-supercalender.

However, if desired, it is possible to further prepare the surface of the fibrous product with conventional surface sizing, for instance with cationic starch, and/or coating it for instance with mineral pigments, such as kaolin, refined or precipitated calcium carbonate, talc, gypsum, plastic pigments or barium sulphate or a mixture of these.

After a treatment according to the present invention, the papers and cardboards are suitable to be used as printing beds. Especially, they can be used as graphic papers, fine papers and papers suitable for inkjet printing.

The following non-limiting examples illustrate the present invention:

### Example A

### Test Aa

### Production of Starch Octenyl Succinate by Using the Aqueous Slurry Method

202 g of starch was elutriated in 200 ml of water. The pH of the mixture was adjusted to 8 with a 0.25 molar NaOH. 10.8 g of octenyl succinic acid anhydride was added and reacted at room temperature while continuously mixing. The pH of the reaction mixture was maintained at pH 8 by adding NaOH. The reaction was allowed to continue for 18 h, after which the pH value of the reaction mixture was set to 6 by using diluted hydrochloric acid, whereafter the mixture was diluted by adding the same quantity of water as was the total quantity of the reaction mixture. The precipitate generated was decanted and washed with water. Further, the precipitate was washed with water-ethanol (1:1 v/v) and thereafter with 94% ethanol. The product was air-dried. The percentages of C and H in the reaction product compared with native starch were determined. The C content of the product was 45.27% and the H content 6.31%, whereas the corresponding values for native starch are: C content 44.85% and H content 6.56%. The increase in the carbon content describes the reaction.

### Test Ab

### Production of Starch Octenyl Succinate in Acetic Acid

The starch was dried by removing the water from it by using azeotropic distillation with toluene. The dried starch, 30 g, 300 ml of acetic acid and 50 g of sodium acetate were mixed. Into the mix, 53 g of octenyl succinic acid anhydride was added. The temperature of the reaction mixture was raised to 100° C. for a period of three hours. 34 g of octenyl succinic acid anhydride was added and reacted for a period of 12 h. The homogeneous reaction mixture was diluted with water. The generated precipitate was washed three times with a mixture of ethanol-water and finally with 90% ethanol. The filtered product was air-dried and the drying was continued at a temperature of 80° C. From the product, the degree of substitution was determined by hydrolyzing the ester bond with an alkali and analyzing the released acid by using chromatography. The measured degree of substitution was 0.31.

### Test Ac

Production of Starch Octenyl Succinate, with Pyridine as the Catalyst and Cosolvent

Potato starch (60 g, 0.37 mol) was dissolved in DMSO (200 g). The result was a clear viscous solution. Pyridine (88 g, 3×0.37 mol) was added into the solution, and, after that, an OSA reagent (octenyl succinic acid anhydride, 194 g, 2.5×0.37 mol). After the addition of the reagent, the temperature of the bath was raised so that the inner temperature of the reaction mixture was 90-100° C. The reaction was allowed to continue for 6 h. The product was precipitated from the water and the sediment was washed with water. The generated raw product was dissolved in acetone and water was added. The acetone was vaporized from the generated dispersion and, after that, the dispersion (A1) was used in the coating tests.

### Example B

### Production of Carboxymethyl Starch (A2), with Sodium Hydroxide as the Catalyst

Potato starch (585 g) was elutriated in ethanol. An aqueous solution of sodium hydroxide was added into the mixture, which was then mixed (20 min). Monochloric acid (80%, 294.6 g) was added and the temperature of the mixture was raised to 58° C. The mixture was reacted for a period of 2 h. The reaction mixture was poured into a surplus of water, and then the mixture was neutralized and washed with ethanol. Finally, the precipitate was filtered, dried and refined.

Yield: 820 g

Dry matter content: 93.7%

1% aqueous solution, viscosity: 185 cP (sP 1, coefficient 5)

Decomposition temperature: 253° C.

### Example C

### Production of Hydroxypropyl Starch (N2, N4, N5)

Hydroxypropyl starch was produced with a method according to Example 3 of the VTT Technical Research Centre of Finland, FI Patent Specification 107930, by using potato starch as the initial material. The quantity of the propylene oxide was chosen according to the target degree of substitution. On the basis of the NMR analyses, the degrees of substitution of the products were:

| | |
|---|---|
| N2 | MS 0.5 |
| N4 | MS 0.3 |
| N5 | MS 0.6 |

### Example D

### Test D1 Acetylation of Hydroxypropyl Starch, with Sodium Hydroxide (N3) as the Catalyst

Acetic acid (550 g) and acetic anhydride (350 g) were mixed with each other and added into a flask which was equipped with a mixer and a reflux condenser. 250 g of hydroxypropyl starch according to Example C was elutriated into the mixture, after which the temperature of the reaction mixture was raised to +40° C. A 50% aqueous solution of sodium hydroxide (27.5 g, i.e. 11% of the quantity of the hydroxypropyl starch), which was used as the catalyst, was carefully added into the flask.

After the addition of the catalyst, the temperature of the bath was raised to 115° C. The mixture was immediately thickened, and, as a result, the hydroxypropyl acetate was precipitated from the water and washed, until the pH of the filtrate was 5. The precipitate was dried in a heating chamber.

Yield: 220 g, degree of substitution: 0.7

Dry matter content: 93.8%

Brookfield viscosity of the 2% aqueous solution was 109 cP.

### Test D2

Acetylation of Hydroxypropyl Starch to a Degree of Substitution of 2.5, with Sodium Acetate as the Catalyst

The hydroxypropyl starch acetate was produced with a method according to Example 2 of the VTT Technical Research Centre of Finland, FI Patent Specification 107930.

### Example E

### Production of an Aqueous Dispersion from Acetylated Hydroxypropyl Starch (N1)

The aqueous dispersion was produced with a method according to Example 4a of the VTT Technical Research Centre of Finland, FI Patent Specification 113874.

### Example F

### Production of Starch Acetate from Cationic Starch (C1)

Spray-dried Raibond (Ciba Specialty Chemicals Oy, DScat 0.2), acetic anhydride and sodium acetate were mixed with each other. The quantities of the reagents calculated as dry matters were according to the formula below.

### Formula:

| kg | |
|---|---|
| 7.9 | Dried Raibond |
| 18.7 | Acetic anhydride |
| 5.9 | Acetic acid |
| 0.6 | Sodium acetate |

The reaction mixture was heated at 60° C. for a period of approximately 30 min, and then further at 115° C. for a period of 4 h. After that, the mixture was poured into 200 litres of water and neutralized with NaOH to a pH value of 5. By ultrafiltration (membranes cut-off 9000), the salts and reagent residues were removed from the reaction mixture. The ultrafiltration was continued until the conductivity of the filtrate was <2 mS.

The product was spray-dried and the degree of substitution, DS acet, was 2.3.

### Example G

### Degrading of Hydroxypropyl Starch (N2) into Different Molecular Sizes

Hydroxypropyl starch N2 was degraded with sulphuric acid into smaller molecular sizes, by using sulphuric acid. Reactants:

2 M sulphuric acid 450 ml
150 g N2 starch

The hydrolysis was carried out at room temperature while stirring the reaction mixture. Hydrolysates with three different molar masses were prepared by using the hydrolysis times 24, 48 and 216 hours.

After the hydrolysis, the reaction mixture was neutralized with sodium hydroxide and ultrafiltered. In the ultrafiltration, the membranes cut-off values used were 10,000 for the higher molecular weights, and 5,000 for the lowest molecular weight. The ultrafiltered product was freeze-dried. The molecular weights of the products were determined by using the SEC technology, and using pullulanes as standards. The molecular weights (M_{W}) were:

| | | |
|---|---|---|
| N2 | 2 000 000 | g/mol |
| N2 24 h | 1 500 000 | g/mol |
| N2 48 h | 500 000 | g/mol |
| N2 216 h | 16 000 | g/mol |

The properties of the based papers used in the examples were:

| | LWC base | | |
|---|---|---|---|
| Property | paper | FP base paper | FP pre-coated |
| Grammage (g/m²) | 47 | 60 | 65 |
| Ash content (%) | 10.5 | 14.0 | 14.4 |
| Air permeance (ml/min) | 200 | 500 | 205 |

### Example 1

Laboratory gravure printing tests were carried out for polymer treated base paper which had no mineral coating, by using an ITG gravure printing equipment. Polymer had been added at 0.3 g/m² onto the surface of the base paper, only on the side to be printed. A base paper which had not been treated with polymer and which had no mineral coating, as well as a mineral coated base paper (commercial gravure printing paper quality) with a mineral coating of 12.5 g/m²/side, were used as reference samples.

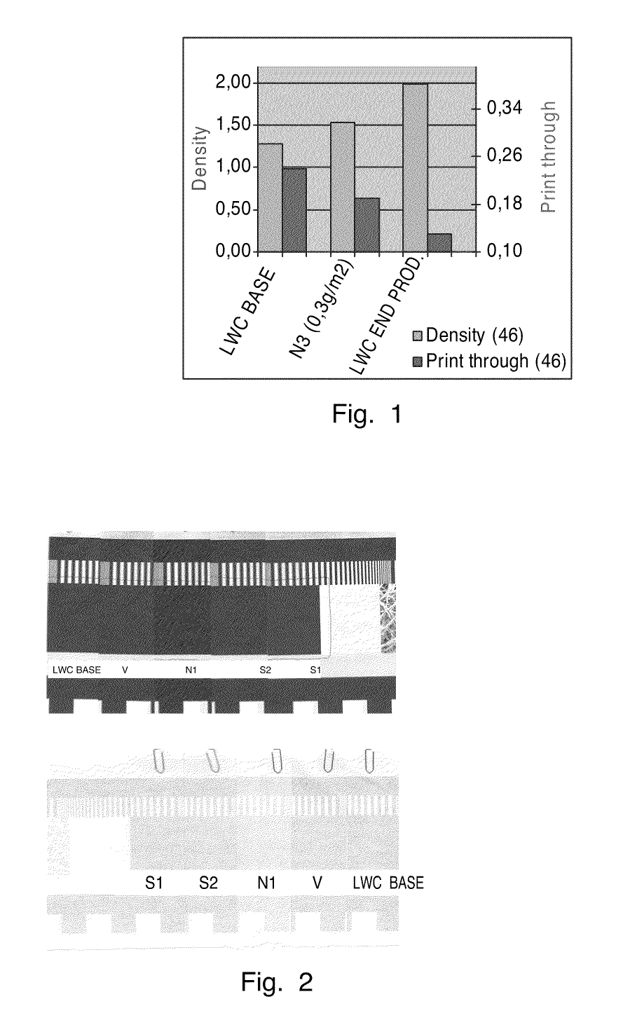

The non-ionic starch ether ester had a significant effect on the gravure printing result of the paper. The density of the imprint was improved by approximately 20% and the print-through was reduced by approximately 21%, as shown in FIG. 1. FIG. 1 is a bar chart showing the results of the IGT gravure printings when a non-ionic starch ether ester was used. A base paper which was not treated with polymer and which had no mineral coating (LWC BASE), and a commercial mineral coated paper for gravure printing, which was made of the same base paper, were used as reference samples.

It should be pointed out that clogging of the pores cannot explain the results, because with some reference polymers, the air permeance achieved was the same but the changes in density and print-through were smaller.

### Example 2

A base paper with no mineral coating was coated with a small quantity of polymer, ≦0.2 g/m², and a pilot-scaled single-colour gravure printing was carried out by using a TAPIO LPM printing press and toluene-based black test ink (Sun Chemicals 67-72692).

A base paper with no mineral coating and which had not been treated with polymer was used as a reference sample.

FIG. 2 shows side by side pieces cut from the five different printing samples. The upper figure shows the samples from the printed side and the lower figure shows the samples scanned from the reverse side.

When the printed sides and the reverse sides of the fully printed surfaces in the figures are compared with each other, it can be clearly seen that the paper (N1), which is surface treated with starch ether ester, prevents the printing ink from penetrating deep into the structure of the paper and thus reduces the harmful print-through. S1 and S2 are base papers which are treated with different synthetic polymers. LWC BASE is a base paper sample which is not treated with polymer and V is a base paper sample which is not treated with polymer but it is water treated.

### Example 3

Offset printing was simulated in the laboratory by determining the absorption of different solutions into samples, which are coated with small quantities of polymer, by using a FC Print measuring device.

Base papers which are treated with plain water and mineral coated end products (commercial printing papers) were used as references for the results. The water treated base paper was used in the comparison because it was desired to separate those changes in the surface properties of the paper, which were purely water-related, from the properties of the paper surfaces, which were treated with a polymer solution.

The polymer is always applied onto the surface as an aqueous solution, after which drying takes place. However, the properties of the water-treated base papers were similar to those of the original base papers. The mineral coating quantity of the LWC paper, which was used as the reference sample, was 12.5 g/m²/side and the mineral coating of the fine paper was 15 g/m²/side.

The anionic starch octenyl succinate almost totally prevented the absorption of water into the fine paper base, although the quantity of the polymer in the surface of the paper was only 0.3 g/m².

FIG. 3 shows the water absorption results when a non-ionic hydroxypropyl starch (N2) and an anionic starch octenyl succinate (A1) are used. A water treated fine paper base (WATER) with no mineral coating and a commercial offset printing paper (FP end) which is made of the same base paper and which is mineral coated, were used as references. To the right are shown the drop patterns of the absorption of a water drop into the samples, which are treated with water and octenyl succinate, after t=5.0 seconds. The lighter the point of the drop turns in the pattern, the more the drop is absorbed through the surface layer.

The same polymer also reduced the absorption of a mineral oil into a fine paper base.

FIG. 4 shows the mineral oil absorption results when a non-ionic hydroxypropyl starch (N2) and an anionic starch octenyl succinate (A1) are used. A water treated fine paper base (WATER) with no mineral coating and a commercial offset printing paper (FP end) which is made of the same base paper and which is mineral coated, were used as references. To the right are shown the drop patterns of the absorption of a mineral oil drop into the samples, which have been treated with water and hydroxypropyl starch, after t=5.0 seconds.

The non-ionic hydroxypropyl starch (0.5 g/m²) reduced the absorption of the mineral oil even more than the anionic starch octenyl succinate. The non-ionic hydroxypropyl starch (0.5 g/m²) also reduced the absorption of water but, however, not in the same way as the anionic starch octenyl succinate. Consequently, it is possible to tailor both the hydrophilicity/hydrophobicity and the oleophilicity/oleophobicity of the surface of the paper.

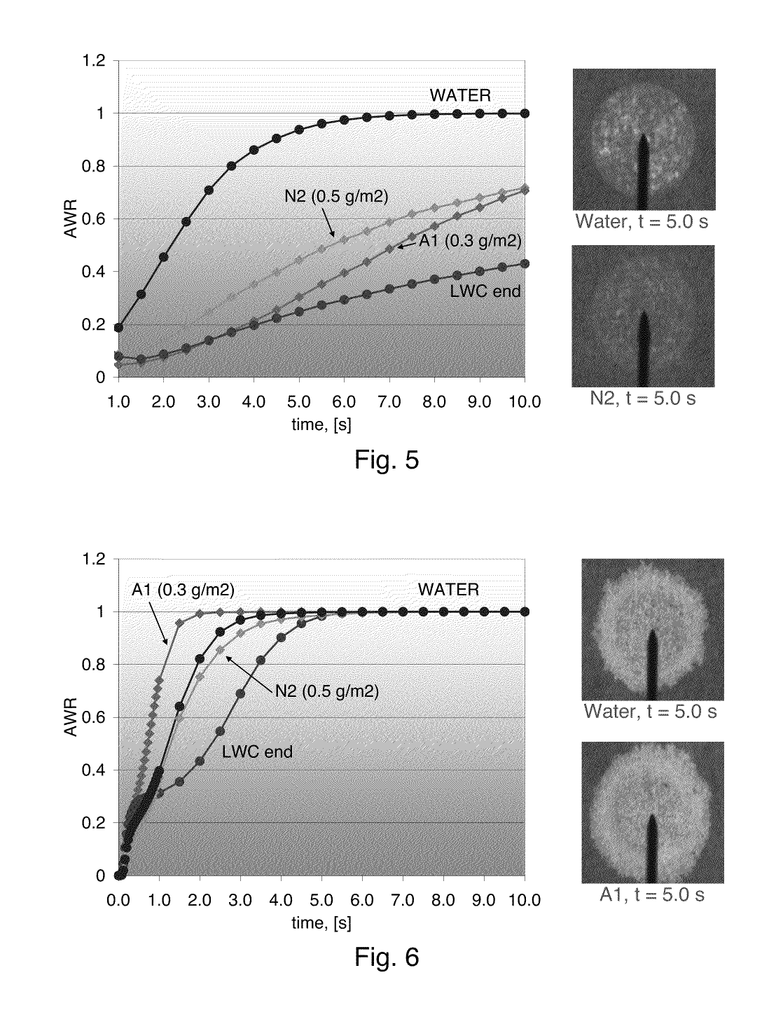

When using wood-containing LWC paper, both the non-ionic hydroxypropyl starch and the anionic starch octenyl succinate, significantly prevented the absorption of the mineral oil into the base paper, almost in the same way as when a mineral coated (12.5 g/m²/side) end product is used. FIG. 5 shows the mineral oil absorption results when a non-ionic hydroxypropyl starch (N2) and an anionic starch octenyl succinate (A1) are used. A water treated fine paper base (WATER) with no mineral coating and a commercial gravure printing paper (LWC end) which is made of the same base paper and which is mineral coated, were used as references. To the right are shown the drop patterns of the absorption of a mineral oil drop into the samples, which are treated with water and hydroxypropyl starch, after t=5.0 seconds.

FIG. 6 shows the pre-absorption results when a non-ionic hydroxypropyl starch (N2) and an anionic starch octenyl succinate (A1) are used. A water treated fine paper base (WATER) with no mineral coating and a commercial gravure printing paper (LWC end) which is made of the same base paper and which is mineral coated, were used as references. To the right are shown the drop patterns of the absorption of a water drop into the samples, which are treated with water and octenyl succinate, after t=5.0 seconds.

The anionic starch octenyl succinate increased the hydrophilicity of the LWC paper (FIG. 6), even though the same starch had made the surface of fine paper significantly hydrophobic (FIG. 3). Consequently, it is possible to tailor the surface of paper in a desired direction.

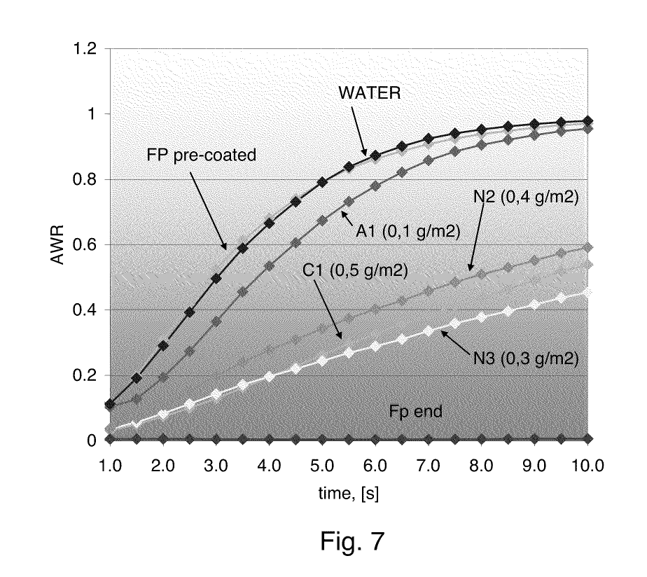

Polymer treatments were also carried out on fine paper which had been pre-coated with mineral pigment (the quantity of the mineral pigment coating was 2.5 g/m²/side), and the absorption properties were analysed. The results for four starch modifications are shown in FIG. 7: anionic starch (octenyl succinate), non-ionic hydroxypropyl starch, non-ionic hydroxypropylated potato starch acetate and cationic starch. A fine paper (FP pre-coated) which was pre-coated with mineral pigment, a water treated mineral coated fine paper (WATER) and a commercial offset printing paper (FP end) which had been mineral coated twice, were used as references.

As the figure shows, coating of the pre-coated fine paper with an anionic starch octenyl succinate (A1 0.1 g/m²), a non-ionic hydroxypropyl starch (N2 0.4 g/m²), a non-ionic hydroxypropylated potato starch acetate (N3 0.3 g/m²) and with a cationic starch acetate (C1 0.5 g/m²), decreased the absorption of mineral oil into the sample. Consequently, with a modified starch polymers, it is possible to tailor the absorption properties of samples which have been coated with mineral pigment, too.

### Example 4

Dynamic inkjet test printings were carried on polymer treated base papers which had no mineral coating. In the test, a small drop (80 pl) of glycol-based inkjet printing ink was applied onto the surface of paper by using an inkjet printer (Spectra), and the behaviour of the drop on the surface was filmed by using a high-speed camera (Hisis).

The filming speed chosen was 160 pictures per second. The surface area, the diameter length, the perimeter and the roundness of the drop, were measured as a function of time.

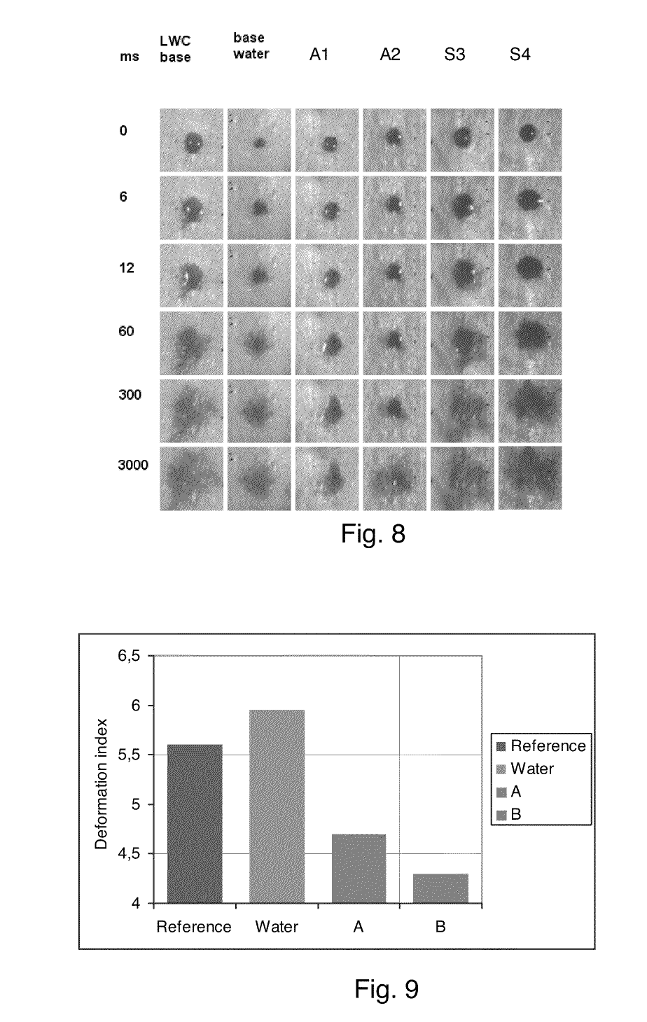

FIG. 8 describes how the inkjet printing ink drop acts when papers, which have been treated in different ways, are used. The time scale is shown on the left of the figure (0-3000 ms). The figure shows that when a base paper is used, which has been treated with an anionic starch ether (A1 0.5 g/m²), the penetration of the printing ink is slower, the spreading is less and the dots have more distinct edges than in the untreated reference. The anionic starch ester (A2), too, makes the penetration of the printing ink slower. S3 and S4 are synthetic polymers. Again, a base paper (LWC base) which was not mineral coated or polymer treated and a water treated base paper (base water), were used as reference samples.

### Example 5

A curl test, which corresponds to electrophotographic printing, was carried out on mineral coated base papers, which were polymer treated on each side. In the test, a momentary single sided high temperature (200° C.) is exerted on the sheet in a nip formed of two rollers. Typically, as a result of a single sided change of moisture content, a permanent curl is generated in the sheet, which curl has a negative effect on the appearance and the usability of the sheet. In the test arrangements, the curl of the sheet is measured before and after the printing by using image analysis, when the moisture content of the sheet has evened out. As a result, a unitless deformation index is achieved, which describes the total deformation of the sheet in the test situation. A smaller index number refers to a smaller deformation.

FIG. 9 shows that those papers, which have been treated with cationic starch acetate A (Example F) and non-ionic hydroxypropyl starch B (Example C), have a significantly smaller total deformation in the test than the untreated base paper (Reference) and the water treated reference (Water), which were used as references. The most probable reason for this is that the transmission of moisture in the structure of the paper is decelerated and that the single sided vaporization is smaller.

### Example 6

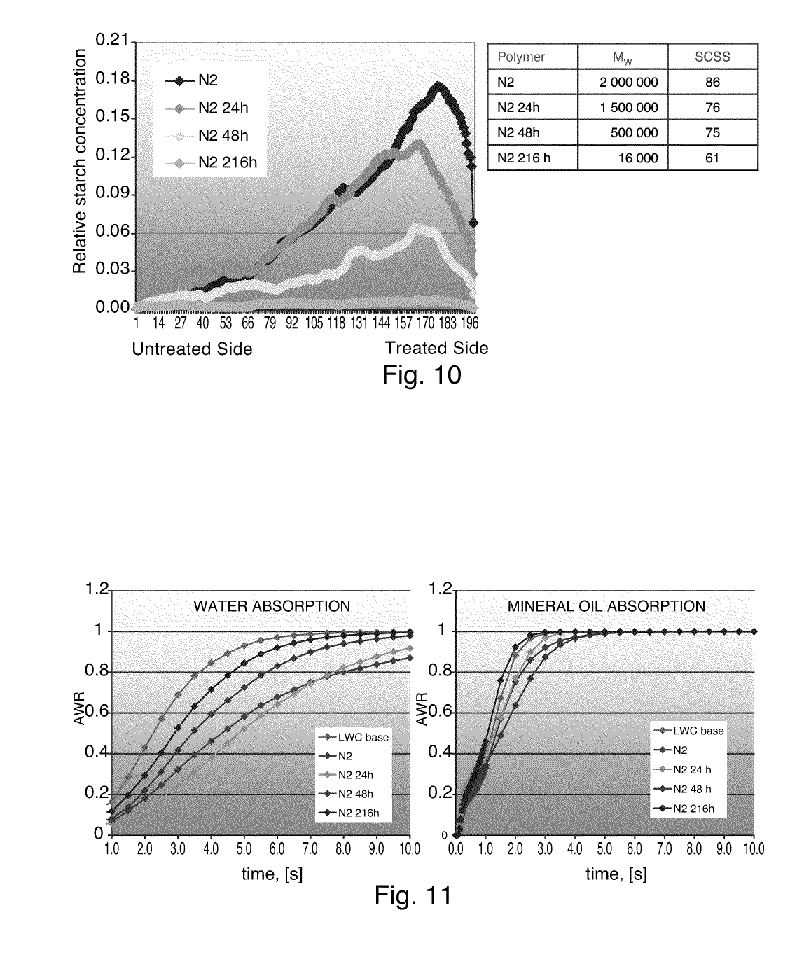

The effect of the molecular weight (MW) of starch on the penetration of the starch solution into paper was tested using neutral potato based hydroxypropylated starch solutions (N2×h), which had been degraded to different molecular weights (2,000,000, 1,500,000, 500,000 and 16,000), by using acid hydrolysis. The starch solutions were applied, at a consistency of 3%, onto the surface of LWC and fine paper by spraying, in which case the quantity of the applied starch in the paper was 0.5 g/m². The penetration of the starch into the paper was analyzed by using a method of determining the crosswise starch distribution in the paper (FIG. 10). The abbreviation SCSS which is used in the figure comes from the words “starch content on sprayed side” and it tells how much (%) of the starch, counted from the midpoint of the depth, remains in the side of the treatment. The figure shows that the bigger the molecular weight of the starch is, the more of the starch remains in the surface of the paper.

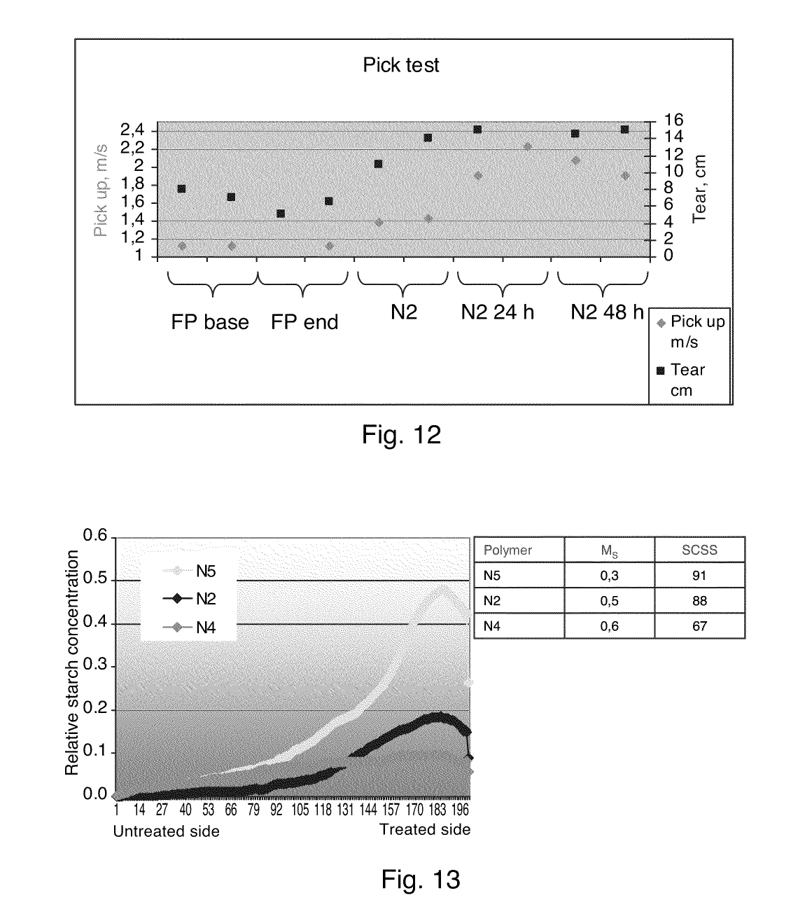

The molecular size also affects the absorption properties and the surface strength of the paper. When the paper was treated with the starch polymer having the smallest molecular size (N2 216 h, M_{W} 16,000), the mineral oil absorption was not reduced and even the water absorption was reduced very little (FIG. 11). In the figure, the water absorption results are shown on the left and the mineral absorption results on the right, as a function of time. Instead, treatment with the starch polymers having a bigger molecular weight reduced both the mineral oil absorption and, particularly, the water absorption. All the polymers improved the surface strength of the fine paper IGT. However, the hydroxypropylated potato starch which had the biggest molecular size (N2, M_{W} 2,000,000) improved the surface strength least (FIG. 12).

The effect of the degree of substitution (MS) of the modified starch was tested by using the same methods with which the effect of the molecular size was tested. Hydroxypropylated potato starch which had been modified to three different degrees of substitution (MS 0.3, 0.5 and 0.6) were used in the examination. The starch solutions were applied, at a consistency of 3%, onto the surface of LWC and fine paper by spraying, in which case the quantity of the starch in the paper was 0.5 g/m².

FIG. 13 shows the effect of the degree of substitution on the distribution of starch in the z-direction in LWC paper. The highest percentage of starch remaining in the surface of the LWC paper (SCSS 91%) was generated by the least substituted starch (N5; MS 0.3), which was least hydrophilic, too. Correspondingly, the most substituted starch (N4; MS 0.6), which was the most hydrophilic, too, had the biggest penetration into the paper (SCSS 67%).

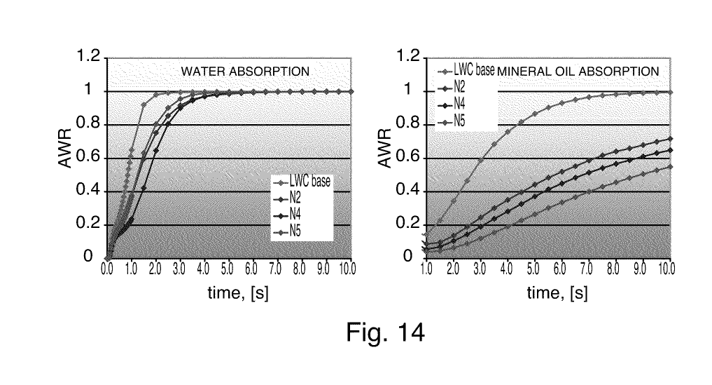

All three hydroxypropylated potato starches having different degrees of substitution delayed the absorption of both water and mineral oil (FIG. 14). On the left in the figure are shown the water absorption results and on the right the mineral absorption results, as a function of time.

However, no significant effect of the degree of substitution of the hydroxypropylated starch (MS 0.3-0.6) on the absorption properties of the paper which was treated with starch, could be observed.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method of modifying the printability properties of a fibrous product comprising paper or cardboard, wherein a small amount of a modified starch is applied on at least one side of the fibrous product.

2. The method according to claim 1, wherein the modified starch is applied in an amount of 0.01-1.0 g/m²/side of the fibrous product, in particular approximately 0.05-0.5 g/m²/side of the fibrous product.

3. The method according to claim 1 wherein the modified starch can be dissolved or dispersed in water, in order to generate a diluted aqueous composition which is sprayable.

4. The method according to claim 1, wherein on the hydrophilic fibre surface is applied a modified starch which comprises hydrophilic structures and, correspondingly, on a hydrophobic fibre surface is applied a modified starch which comprises hydrophobic structures.

5. The method according to claim 1, wherein the hydrophilic fibre surface comprises a web which is formed of chemical pulp.

6. The method according to claim 1, wherein the hydrophobic fibre surface comprises a web which is formed of lignocellulose pulp.

7. The method according to claim 1, wherein starch ether esters, anionic starch esters, or starch ethers or esters, are used as modified starch.

8. The method according to claim 7, wherein an esterified hydroxy-lower alkyl-starch, especially acetylated hydroxypropyl starch, are used as the modified starch ether esters.

9. The method according to claim 7 wherein the molecular degree of substitution of the hydroxyalkylated starch ester, MS, is 0.5-5 and the degree of substitution of the ester groups, DS, is 0.1-3, preferably the MS of the hydroxypropyl starch acetate is 0.05-2 and the DS 0.3-3.

10. The method according to claim 7, wherein starch alkenyl succinate, in which the alkenyl group is derived from an alkene comprising 2-24 carbon atoms, are used as the anionic starch esters.

11. The method according to claim 7, wherein a carboxy-lower alkyl-starch or a hydroxy-lower alkyl-starch, are used as the starch ethers.

12. The method according to claim 1, wherein the modified starch is an anionic starch octenyl succinate, a non-ionic hydroxypropyl starch, a non-ionic hydroxypropylated potato starch acetate or a cationic starch.

13. The method according to claim 1, wherein the modified starch is applied onto the surface of the substrate in the form of an aqueous solution, emulsion, colloidal mixture or a dispersion.

14. The method according to claim 13, wherein the concentration of the modified starch is approximately 0.5-10% of the weight of the emulsion, colloidal mixture or dispersion of the solution.

15. The method according to claim 1, wherein the modified starch is applied onto the surface of the substrate by using roll coating, curtain coating or spray coating.

16. The method according to claim 1, wherein the substrate which is formed by a fibrous material comprises a paper or cardboard web.

17. The method according to claim 1, wherein the modified starch is applied onto the surface of the fibrous product in the form of a dispersion or an emulsion, in which case, after the application, the modified starch remains on the surface in the form of discrete dots or drops or spots.

18. The method according to claim 1, wherein the paper or cardboard web, which has been treated with the starch modification, is calendered after the polymer treatment.

19. A fibrous product, the absorption and desorption properties of which have been improved and which comprises a fibrous web which has, on at least one of it surfaces, a small quantity of starch modification.

20. The product according to claim 19, wherein it comprises 0.01-1 g/m², preferably at maximum 0.8 g/m², of a modified starch.

21. The product according to claim 19 wherein the modified starch can be dissolved or dispersed in water, in order to generate a diluted aqueous solution which is sprayable.

22. The fibrous product according to claim 19, wherein the modified starch is a starch ether ester, an anionic starch ester or a starch ether.

23. The fibrous product according to claim 22, wherein the modified starch is a starch octenyl succinate, a non-ionic hydroxypropyl starch, a non-ionic hydroxypropylated potato starch acetate or a cationic starch.
